(19) United States
(12) Patent Application Publication
(10) Pub. No.: US 2010/0213134 A1
(43) Pub. Date: Aug. 26, 2010

(54) ION EXCHANGE APPARATUS HAVING INCREASED EFFICIENCY

(76) Inventor: Robert M. Campbell, Claremont, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/695,823

(22) Filed: Jan. 28, 2010

Related U.S. Application Data
(60) Provisional application No. 61/151,594, filed on Feb. 11, 2009.

(51) Int. Cl. C02F 1/42

(52) U.S. Cl. 210/682; 210/285; 210/681

(57) ABSTRACT

An embodiment of the inventive apparatus comprises a conical, elliptical or dish bottom vessel with bottom flow strainers containing a combination of a layer of anthracite particles covering the strainers and acting as a flow dispersion layer and an ion exchange bed to remove ionic contaminants from water. In an embodiment of the invention, removal of ionic contaminants in water by ion exchange and volume reduction of the ion exchange resin bed after attainment of bed exhaustion or defined point of reduced activity is affected by treating the water with an apparatus comprising a conical, elliptical or dish bottom vessel with bottom flow strainers containing a combination of a layer of combustible particles acting as a flow dispersion layer and an ion exchange resin bed, followed by combusting together the ion exchange bed and anthracite particles. In an embodiment of the invention, removal of radionuclides from water by ion exchange and volume reduction of the ion exchange resin bed after attainment of bed exhaustion or defined point of reduced activity is affected by treating the water source with an apparatus comprising a conical, elliptical or dish bottom vessel with bottom flow strainers containing a combination of a layer of combustible and non-radionuclide sorbing particles acting as a flow dispersion layer and an ion exchange resin bed, followed by combusting together the ion exchange bed and a combustible and non-radionuclide sorbing particles.

### CROSS REFERENCE TO RELATED APPLICATION AND PRIORITY CLAIM

This invention claims the benefit under 35 U.S.C. §119(e) of copending U.S. Provisional Application No. 61/151,594 filed Feb. 11, 2009 entitled ION EXCHANGE VESSEL HAVING INCREASED EFFICIENCY which is hereby incorporated by reference herein in its entirety.

### FIELD OF THE INVENTION

This invention pertains to ionic contaminant removal from water and waste water by an ion exchange vessel with improved flow produced through the use of a flow dispersion layer in an ion exchange containing vessel. The use of a combustible and non-uranium adsorbing flow dispersal layer is of particular advantage for uranium removal in water remediation for production of drinking water.

### BACKGROUND OF THE INVENTION

Ion exchange is a process used to remove ions from water, which may be undesirable or harmful. Ion exchangers remove undesirable ions from water by exchanging these for ions which are innocuous or less harmful. In practice the water to be treated is contacted with a bed of solid ion exchange particles. Naturally occurring inorganic zeolites or polymeric organic resins are used. Organic resins are predominately used because different exchanger chemistries can be synthesized for various applications. Organic ion exchange resins are high-molecular-weight crosslinked polymers having appended functional groups with exchangeable ions. The ions on the resin are replaced by ions of the same charge from the water being treated.

There are four basic categories of ion exchange resins are defined by the chemistry imparted to them in their synthesis. These are Strong Acid Cation (SAC), Weak Acid Cation (WAC), Strong Base Anion (SBA) and Weak Base Anion (WBA)

SAC resins get their functionality from sulfonic acid groups (RSO₃⁻H) and are used to neutralize strong bases and convert neutral salts into their corresponding acids and remove positively charged ion (cations) such as calcium (Ca⁺⁺) and Cupric (Cu⁺⁺). WAC use the carboxylic group (RCOOH) for functionality. SBA resins are based on quaternary ammonium functional groups and will neutralize strong acids, produce the corresponding bases from neutral salts, and remove negatively charged ions (anions) such as sulfate (SO₄⁺⁺) and perchlorate (ClO₄⁻¹). These resins are utilized in most softening and full demineralization applications. WBA use one or more of primary, secondary or tertiary amine groups for functionality.

Ion exchange processing is done by batch or column methods. The batch method simply mixes the water to be treated with a quantity of resin and after equilibrium is reached the resin and water are separated. The more common column method is a typical chemical processing method of passing the water to be treated through a bed of ion exchange media until the bed is exhausted or reaches its breakthrough point (i.e., no longer effectively removes the ion or ions of interest to the predetermined limit or concentration). The ion exchange beads are poured or installed into the vessel to a suitable depth, i.e., the bed. The bed is called media, resin, resin bed, media or similar in describing the bed. When the resin has reached the breakthrough point, the bed is usually regenerated by passing a solution of acid, base or brine through the bed, depending on the type of media used for exchange.

Ion exchange is used in many waste water treatment processes where uranium is present. Since high levels of uranium in drinking water may increase the risk of cancer and kidney damage, the U.S. Environmental Protection Agency (EPA) has set a Maximum Contaminant Level (MCL) for uranium of 30 μg/L as Safe Drinking Water Limits, primarily because of the heavy metal toxicity of uranium, not its radioactivity. More than 500 community water systems nationwide will need to take measures to reduce the uranium in their drinking water supply because they have uranium levels in the water greater than 30 μg/L by EPA estimates. A study (Mineral Processing and Extractive Metallurgy Review, Volume 25, Issue 2 January 2004, pages 129-142) describes removal of uranium from acid mine drainage.

Over 90% of uranium can be removed by ion exchange using anion resin in the chloride form. Mixed beds of cation and anion resins are sometimes used to remove both radium and uranium. One concern for users of ion exchange in these processes is that the U.S. Department of Transportation regulates the transportation and handling of low level radioactive waste to a reported level for uranium of 2,000 picoCuries per gram of media. Radium is more highly radioactive and more closely controlled. If the bed media is to be transported after use to be further processed in a regulated facility, it is incumbent on users to most efficiently use the bed media.

Column systems use one or more fixed-bed columns. The number and type are defined by the amount and type of ions to be removed. The columns are primarily cylindrical vessels or tanks; herein the terms are used interchangeably, with shaped bottoms. That is, the vessel bottom is elliptical, dished, or conical, terms that are known to those skilled in the art of design and use of chemical processing tanks or vessels. The system includes the various piping, valves, and instruments required for controlling flows of the several fluids; feed, regenerant and backwash solutions. The vessel has at least one inlet for water to be treated and for regenerant liquid used in co-current regeneration. The inlet also serves as an outlet for regenerated liquid when countercurrent regeneration is used. The purpose of the tanks is to contain the ion exchange media and provide means to uniformly distribute the feed and regeneration flows so that channeling or other mal-distribution of flow does not occur. The column must be sized so that there is sufficient space to provide for expansion during backflushing or backwashing and also after regeneration where media expansion of up to 30% may occur.

Some ion exchange columns require flow in two directions, an operating (generally a downward) direction and a backwash or backflush (generally upward) direction. The backwash step in ion exchange resins is used to remove dirt and broken or fine ion exchange particles, removes any channeling or compaction of the bed, and, particularly in mixed bed (cation and anion) ion exchangers, to separate the anion and cation resins which have different densities and can therefore be separated by floatation. Backflushing is done at a slow flow rate upward through the media to gently remove solids from the top of the media bed that may accumulate. It does not entail media fluidization.

Regeneration is done either by cocurrent or countercurrent methods. Cocurrent columns use the same flow direction (generally downflow) for both feed and regenerant solutions. Countercurrent systems flow the regenerant in the opposite direction (generally upward) of the feed flow, which more efficiently exchanges the regenerating ions.

Single resin ion exchange beds may use a countercurrent (upward) regenerant flow. This results in a lower leakage of ions during purification because the last (lower) portion of the ion exchange resin to contact the liquid being purified has also been exposed to the largest portion of fresh regenerant chemical. It is important for the regenerant solution to contact all of the resin between the strainers. Resin which does not become completely regenerated will cause undesirable leakage of ions during purification. Therefore it is important to have uniform flow and minimum pressure loss in this region.

Ion exchange can be operated in regeneration mode as described, or in a service mode. In service mode, the ion exchange bed is run to the breakthrough point and the ion exchange bed removed and sent for disposal or incineration/energy recovery. This is the common mode of operation when the bed sorbs ions such as perchlorate which are strongly bound.

At the bottom of the column is the liquid flow system. This system comprises piping to evenly collect the drainage and during countercurrent regeneration, to provide a uniform flow of the backwash. The system must prevent the bed from forming channels during water flow. Channeling can occur due to uneven flow or by removal of bed media through the piping during drainage.

In tanks using perforated piping for the flow system, the ion exchange bed must be retained, that is, kept separate from the drainage piping to prevent loss of beads. There are two commonly used means of retaining the bed. In one method a porous resin retaining plate, such as a wire screen, with screen size sufficient to prevent media particle passage is placed over the drainage and backwash piping or other system used to distribute flow. A filter media support comprising multiple retaining plates is described in U.S. Pat. No. 6,261,453. Another common means comprises multiple layers of graded gravel or other mineral particles forming a media support. These means prevent media particles from entering the drainage piping and being lost, and causing mal-distribution of the bed, and subsequent channeling or poor performance.

In U.S. Pat. No. 1,787,698, gravel bed supports are described. It is stated that it is common practice to use more than one size of gravel, with larger sizes used for the lower layers and the finest layer for the top layer. The '698 patent places a one or more layers of heavier gravel or other granulated material over the finest layer to prevent channeling. This manner of layering is used to prevent water from channeling and disarranging the gravel support bed. In U.S. Pat. No. 1,891,061, the same inventor states that the '698 patent did not completely solve the problem of channeling and that in the '061 patent they claim a system whereby the incoming water is divided into a series of jets and a series of vertical walls forming cells, with the cells filled with a coarse gravel and a fine gravel layer formed to extend over the vertical plates to form a continuous layer.

Elliptical, dished or conical bottom vessels are used in water and waste water treatment facilities because they provide complete drainage without stagnant regions. These vessels are provided with distribution piping for drainage or removal of treated water, and which is also used to distribute flow during backflushing. The piping, known as laterals, is usually either the hub-radial or header-lateral types. The hub-radial design is usually limited to tanks of about 48 inches diameter. These consist of a hub with hollow, perforated laterals connected to the hub in a radial manner. The header-lateral type consist of a larger header pipe with a multitude of hollow, perforated laterals perpendicularly connected to it in a common plane. The distribution piping may be covered with graded gravel or laid on top of the bed support gravel layer. If the latter, the laterals have to be screened to prevent intrusion and loss of ion exchange beads.

In some cases where it is determined that a gravel layer is undesirable or unwanted, a false bottom is emplaced in the tank holding the ion exchange beads with a series of strainers protruding into the tank from the false bottom. That is, the strainers are connected by piping through the false bottom to connect to the laterals. Strainers are devices that can be as simple as a perforated pipe, closed at one end and wrapped with a woven sheet or other filter or straining mesh to prevent ion exchange beads from entering the drainage system and being removed. Strainers are employed in ion exchange resin tanks in order to permit flow in either direction without a loss of the ion exchange resin particles. A form of strainer known as the Johnson well screen is a common design which comprises a substantially cylindrical unit having in fact a polygonal cross section. The unit comprises a plurality of metal strips of substantially triangular cross section, the apex of said strip pointing inwardly to the center of the unit. The strips are held together by spacer units provided circumferentially around the inner circumference of the filter unit and parallel to the axis thereof. In such a unit the circumferential slots are open for approximately 90% of the circumference of the unit between any pair of slots. The triangular cross section of the strips permits a higher volume of through-put than would be possible if the space between the strips was uniformly small, that is to say restricted to the spacing necessary to exclude the particulate matter in the unit.

To remove the cost and complications engendered by the false bottom, U.S. Pat. No. 5,658,459 describes a system for an elliptical bottom tank in which the strainers descend on pipes from the laterals to touch or be positioned as close as possible to the tank bottom. In other descriptions, strainers protrude upward from the bottom of the vessel. All flow into and out of the bottom of the vessel, such as treated water outflow, backflush inlet and countercurrent regenerant flow goes through the strainers. A general term to describe and denote strainers and associated piping and connections which allow drainage out flow, backflow or regenerant flow is bottom liquid flow strainer. A lateral strainer is another way of describing a strainer fluidly connected to a lateral.

The use of strainers in ion exchange vessels improves performance by eliminating the need for the gravel support bed commonly needed to prevent loss of ion exchange beads. Gravel beds have to be multilayered with the top layers of finer consistency to prevent bead intrusion. These finer consistency layers increase pressure drop and reduces flow through the bed and the vessel and thereby reduces process efficiency. Multilayered beds are more complicated to form as well and this will increase cost.

It has been found that when the soft on exchange media is packed around the strainers, it will compress and produce a higher pressure drop and lower productivity. Additionally, the diameter of the elliptical or conical bottom tank is less than that of the cylindrical tank and the ion exchange sorption per unit height is reduced. Therefore, there is a need to raise the ion exchange bed to approximately the level of the cylindrical portion of the vessel.

Furthermore, there is a need for an improved ion exchange apparatus using dished, conical or elliptical bottom vessels with strainers to remove treated water or provide backflush flow which reduces pressure loss and improves ion exchange bed effectiveness.

### SUMMARY OF THE INVENTION

An embodiment of the invention comprises an ion exchange bed water or waste water treatment apparatus to remove ionic contaminants from water by ion exchange, comprising a conical, elliptical or dish bottom vessel bottom flow strainers containing a combination of a layer of anthracite particles acting as a flow dispersion layer and said ion exchange media bed.

In an embodiment of the invention, the rated size of the anthracite is from about approximately 8 mesh to about approximately 16 mesh, which corresponds to from about approximately 2.38 mm (millimeters) to about approximately 1.19 mm.

In an embodiment of the invention, the rated size of the anthracite is from about approximately 10 mesh to about approximately 14 mesh, which corresponds to from about approximately 2.00 mm (millimeters) to about approximately 1.41 mm.

In an embodiment of the invention, the rated size of the anthracite is from about approximately 1.50 mm (millimeters) to about approximately 1.75 mm.

In an embodiment of the invention, a water or waste water treatment apparatus to remove radionuclides from water by ion exchange, comprises a conical, elliptical or dish bottom vessel with bottom flow strainers containing a combination of a layer of anthracite particles acting as a flow dispersion layer and an ion exchange bed.

In an embodiment of the invention, removal of ionic contaminants in a water source from the water source by an ion exchange media bed and volume reduction of the ion exchange media bed after the breakthrough point is reached is affected by treating the water source with an apparatus comprising a conical, elliptical or dish bottom vessel with bottom flow strainers containing a combination of a layer of combustible particles acting as a flow dispersion layer and said ion exchange media bed, followed by combusting together the ion exchange bed and combustible particles. Most preferred combustible particles comprise anthracite.

In an embodiment of the invention, removal of radionuclides in a water source from the water source by an ion exchange media bed and volume reduction of the ion exchange media bed after attainment of bed exhaustion or defined point of reduced activity is effected by treating the water source with an apparatus comprising a conical, elliptical or dish bottom vessel with bottom flow strainers containing a combination of a layer of combustible and non-radionuclide sorbing particles acting as a flow dispersion layer and said ion exchange resin bed, followed by combusting together the ion exchange bed and combustible and non-radionuclide sorbing particles. Most preferred combustible particles comprise anthracite. An important radionuclide for removal is uranium.

### BRIEF DESCRIPTION OF THE DRAWINGS

FIG. 1 shows a strainer with a threaded pipe connector and flange fittings.

FIG. 2 shows a strainer with a plain pipe connector.

FIG. 3 shows a vessel with an elliptical bottom and strainers protruding from the bottom.

FIG. 4a shows a vessel with a conical bottom and strainer drains protruding from the bottom.

FIG. 4b shows a vessel with a conical bottom within an elliptical bottom vessel and strainer drains protruding from the bottom of the conical bottom, and draining into the volume between the conical and elliptical bottoms.

FIG. 5 shows a vessel with an elliptical bottom and strainers descending from a lateral towards the vessel bottom.

FIG. 6 is a chart illustrating the effect of a flow dispersion layer on reduced pressure drop through an ion exchange media bed.

### DETAILED DESCRIPTION OF THE INVENTION

The inventor has found through careful and thorough experimentation that that a bed of anthracite with an average particle size somewhat larger than the ion exchange beads of the bed media placed in the elliptical or conical bottom section will reduce or eliminate these problems. The anthracite bed acts as a flow dispersion layer and provides for a more uniform flow and lower pressure drop in the elliptical or conical bottom section. This results in more uniform flow through the ion exchange bed and less potential for channeling. Anthracite bed packings have a random particle shape. A thorough study of particles used for filter beds (Siwiec T. 2007. THE SPHERICITY OF GRAINS OF FILTRATION BEDS APPLIED FOR WATER TREATMENT ON EXAMPLES OF SELECTED MINERALS, EJPAU 10(1), #30) showed that anthracite had specific physical properties which the present inventor has found to be particularly useful.

Sphericity of a particle is defined as the ratio of surface of a sphere having the same volume as the particle to the surface of that particle. A sphere has a sphericity of 1.0 and more irregular particles have lower sphericity. Lower sphericity correlates with higher bed porosity and lower bed compaction. A filter bed a properly chosen pore size, which here means the average size of the space between particles which causes filtration of species, will have lower flow resistance for higher porosity. For particles with regular shapes sphericity may be calculated from the ratio described earlier. However, for particles with irregular shapes sphericity has to be determined with experimental methods. The study referenced compared a number of experimental flow methods to determine sphericity for engineering design calculations. Several were found to be useful for design purposes, and in general agreement with each other. However, it was found that microscopic examination gave a clearer definition of the differences in sphericity for the filter bed mineral particles studied. In particular, it was found that anthracite had the lowest sphericity. In addition, microscopic examination showed that a large number of its grains had elongated, stick-like shapes with sharp ends.

The structure of anthracite has low sphericity and higher porosity than ion exchange beads loaded in a column and other mineral particles that might be considered. Therefore there will be lower pressure drop through the total bed depth because the added pressure drop from the anthracite flow dispersion layer is minor compared to the ion exchange bed or an alternative particle of higher sphericity.

Surprisingly, unlike the common used multiple layers, a single layer can be used, although practitioners may find occasion to use multiple layers of different sized particles under certain circumstances, for example, where the ion exchange beads compress into the porous volume of the anthracite and reduce flow. In some cases, it may prove beneficial to have one or more layers of anthracite of smaller sizes as a top layer.

Anthracite is inert and does not sorb radionuclide ions as does activated carbon. Sorb is a term used to describe binding of a substance, here ions, by either or both of adsorption or absorption. If uranium or other radionuclides are present in the water or waste water to be treated, anthracite will in effect reduce the mass loading of the total bed. This allows the ion exchange bed to be operated to a higher absorption capacity per unit weight of beads than if the flow dispersion layer sorbed radioactive ions, or if the entire bed were ion exchange beads. Many other mineral particles for example, gravel, garnet or bone char cannot be considered for this use because they either sorb uranium, as will bone char, or are not combustible, as gravel and garnet.

By using anthracite as the flow dispersion layer, the bed may be transported for further processing, such as concentration in a regulated facility. There the anthracite may be separated and the ion exchange beads treated. This method will be more effective simply using ion exchange, or an underbed that sorbs uranium or other radionuclides, since the beads processed with an anthracite flow dispersion layer will have a higher concentration of radionuclides in a smaller volume than if the media support were absorptive or if no media support were used. The anthracite may be burned for energy or recycled for re-use as a flow dispersion layer.

U.S. Pat. Nos. 4,053,432 and 4,636,335 describe processes for reducing the volume of ion exchange resin used to remove radionuclides. In both a two stage thermal process is used. In the first stage, the resin, after being partially dried is heated to about 350° C. where the functional groups are volatilized. These comprise a small part of the overall resin mass, but produce gaseous nitrogen oxides and gaseous sulfur oxides which require a costly exhaust gas disposal treatment. This is followed by a high temperature decomposition at temperatures at or higher than 500° C., preferably lower than 700° C. to reduce the possibility of formation of volatile radioactive ruthenium and cesium. By removing the nitrogen and sulfur components at low temperature without volatilizing the bulk of the ion exchange resin, a smaller volume has to be treated to remove nitrogen and sulfur.

Using the ion exchange bed and anthracite flow dispersal layer in a thermal process as described will improve the process by maintaining a self-sustaining second stage combustion above the anthracite ignition temperature of about 500° C., given sufficient oxygen present. This is independent of the condition of the ion exchange beads. Other coals may be used, e.g., bituminous, but anthracite is the most preferred coal, because it has the lowest ash content and the highest heat of combustion of coal types. The use of the anthracite flow dispersion layer in this way will reduce cost by reducing the amount of energy that must be added, and eliminating substantially all costs of anthracite disposal.

The apparatus comprises a cylindrical vessel or tank with a shaped bottom holding an ion exchange bed, the preferred bottom shape being elliptical, dish or conical, with one or more strainers positioned in the shaped bottom, the strainers used to remove or drain the process liquid and to input backflush or regeneration flow streams to the ion exchange bed, and at least one layer of anthracite media minimally covering the strainers and preferably filling substantially all of the volume of the shaped bottom so that the ion exchange bed extends upwards from approximately the joining of the cylindrical portion and the shaped bottom portion of the vessel.

The strainers function to prevent or hinder ion exchange beads or other media (e.g., anthracite) from entering the drainage flow and being removed from the vessel. Each strainer may be positioned atop and connected to a pipe section which extends through the bottom of the shaped bottom though a flange or similar connector, or may be simply flanged to the vessel bottom to allow liquid passage. In some cases, the strainers may similarly pass through a false bottom and then pass through the shaped bottom. In an alternative, a solid layer may be formed from cement, for example, which fills the vessel bottom up to the bottom of the strainer cylinder.

The anthracite flow dispersion layer is placed in the vessel to form a bed which minimally covers the strainers and preferably substantially fills the volume of the shaped bottom. The flow dispersion layer prevents ion exchange beads from substantially permeating the anthracite bed, and also to minimize pressure drop through the bed, and to make the flow through the bed uniform. Tanks may be built at lower cost because they can be designed with fewer strainers due to improved flow. The ion exchange resin is better utilized because it is not under the strainers where it basically takes up space and does not efficiently remove ions.

The anthracite is preferably from about approximately 8 mesh to about approximately 16 mesh, which corresponds to from about approximately 2.38 mm (millimeters) to about approximately 1.19 mm. More preferably, the rated size of the anthracite is from about approximately 10 mesh to about approximately 14 mesh, which corresponds to from about approximately 2.00 mm (millimeters) to about approximately 1.41 mm. In an most preferred embodiment, the rated size of the anthracite is from about approximately 1.50 mm (millimeters) to about approximately 1.75 mm.

The strainer used in the may be any suitable strainer, and is not limited by examples shown or described in the present description. For illustration, two types are described.

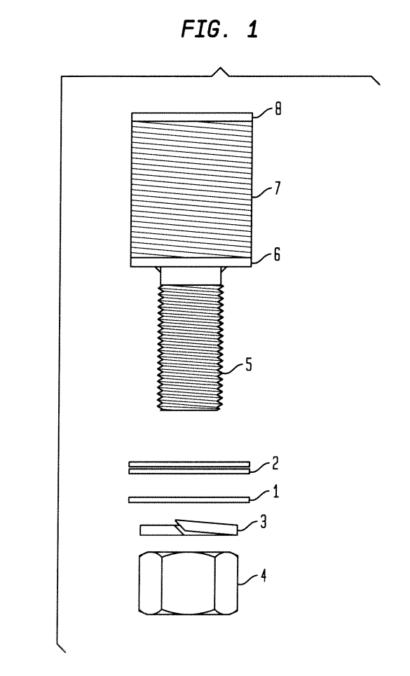

FIG. 1 illustrates a typical design for a strainer with a sealable flange bottom connector. The strainer comprises a flat washer (1), with associated flexible gaskets (2), lock washer (3) and nut (4) for fastening the strainer to the vessel bottom. The gasket material may be any of the known materials, such as Buna N. The strainer head is a wire screen cylinder (7) formed from a wedge shaped wire wrapped around an internal support with a ring shaped bottom (6) to allow connection with the exit pipe (5), here threaded. The strainer head top (8) is a solid round plate.

In use, the strainer is mounted inside the vessel with the threaded pipe (5) passing through the vessel bottom. Gaskets may be placed on the inside of the vessel against the strainer head bottom plate, and against the outside of the vessel bottom and the bolt system tightened.

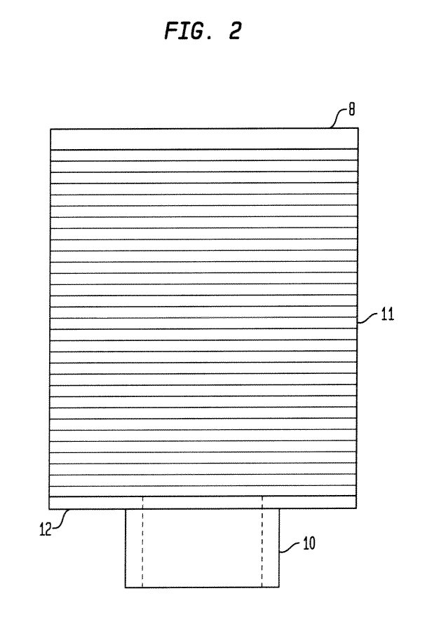

In FIG. 2 is illustrated another style of strainer, a non-threaded connector pipe strainer head. This has the same general construction, with a wire screen cylinder (11) formed from a wedge shaped wire wrapped around an internal support with a ring shaped bottom (12) to allow connection with the exit pipe (10). In this style, the exit pipe is typically welded to a liquid carrying pipe (e.g., drainage, backflush, regenerant) which connects to a header or lateral. The liquid carrying pipe may be welded to the tank bottom. Alternatively, if exit pipe (10) is made long enough, it can pass through the vessel bottom, sealed with, for example, a weld or a flange as described above and be welded or connected with a compression fitting to the liquid carrying pipe. The strainer head top (8) is a solid round plate.

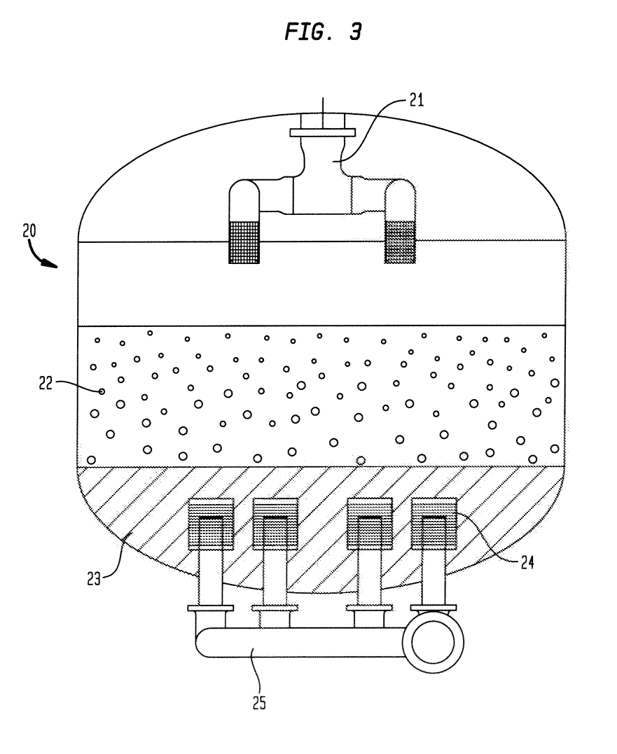

FIG. 3 shows a elliptical bottom vessel (20) with an inlet and flow distributor combination (21) for the liquid to be purified. The ion exchange bed (22) lies on the anthracite bed (23) which covers the strainers. The strainers (24 typical) are mounted on the end of pipes which pass though the vessel bottom and connect to a lateral (25), which may be connected to a header or other piping to remove or bring flow as required. The water stream to be purified is pumped through distributor (21) at a rate that allows the water to flow evenly through the ion exchange bed. The flow continues through the anthracite bed and into the strainers to exit the vessel. In operation, it is important that the flow through the ion exchange bed be uniform to prevent channel formation. If an ion exchange bed experiences uneven flow resistance caused by non-uniformities in a layer below it, flow will necessarily shift unevenly and tend to cause channeling and thereby reduce on exchange in regions of poor flow.

By using a bed of anthracite that provides uniform flow due to the structure of anthracite particles, the inventor has found that flow non-uniformity through the ion exchange bed is greatly reduced. In addition, flow non-uniformity caused by flow resistance caused by beads packing around the strainer heads and building up a layer of compressed beads is eliminated.

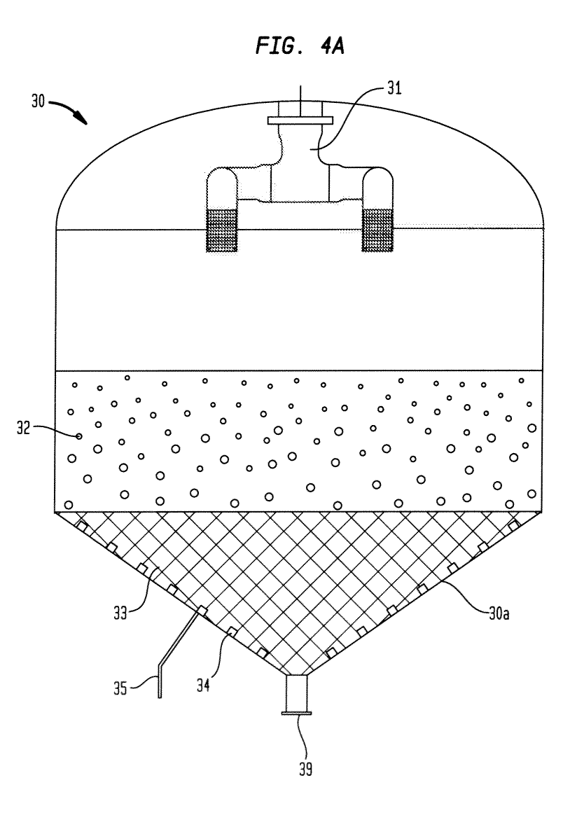

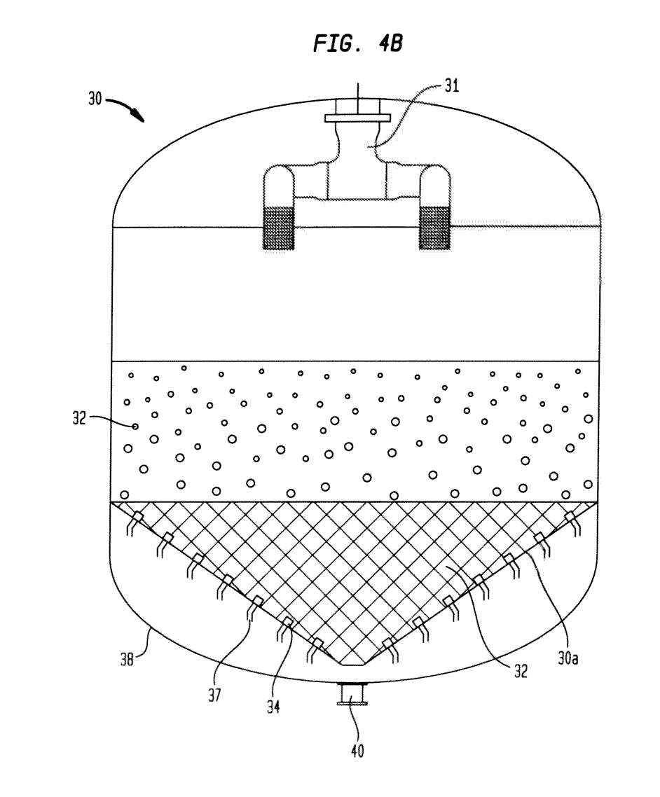

FIG. 4a shows a conical bottom vessel (30) with an inlet and flow distributor combination (31) for the liquid to be purified. The conical bottom (30a) has outlet drain (39). The ion exchange bed (32) lies on the anthracite bed (33) which covers the strainers. The strainers (34 typical) are mounted by sealable flanges (35 typical, not detailed) which pass though the vessel bottom and connect to a lateral which may be connected to a header or other piping to remove or bring flow as required. In operation, this vessel will be operated in the same manner as described above for the elliptical bottom tank.

FIG. 4b shows a vessel (30) with a conical bottom (30a) in an elliptical bottom (38) vessel. The ion exchange bed (32) lies on the anthracite bed (33) which covers the strainers. The strainers (34 typical) are mounted by sealable flanges (37 typical, not detailed) which pass though the conical vessel bottom. The strainers drain treated water through into the space between the conical and elliptical bottoms and it drains from the bottom nozzle (40) on the elliptical bottom.

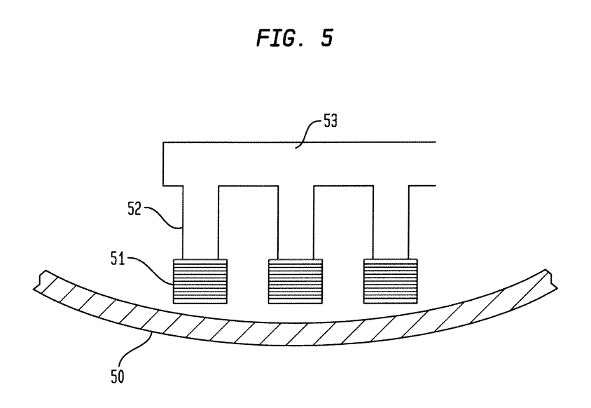

FIG. 5 shows the strainer heads (51 typical) descending on pipes (52) from a lateral (53) in the vessel. The anthracite bed can be at a depth to cover the heads, or the lateral, or to some intermediate depth and to substantially fill the volume of the shaped bottom. The depth will be determined by the depth needed to assure a uniform flow.

Uranium occurs naturally in many geological strata and is found in aquifers because it is soluble in low concentration. Suppliers of domestic drinking water in certain parts of the world pump water from wells drilled into these aquifers. The concentration of uranium is well below drinking water standards set by federal, state and local regulations. However, other contaminants must be removed before the water is fit for consumption. Examples of such contaminants are nitrate and perchlorate, which are both present in aquifers as a result of human activity and improper waste disposal in years past, and due to natural occurrence.

The perchlorate anion (ClO₄⁻) is a primary component in explosives, rocket and missile solid propellant and fireworks. Perchlorate is found in about 4% of public water systems in the US. In California, Arizona and Nevada, over 20 million people are using water polluted with perchlorate. Perchlorate interferes with iodide uptake into the thyroid gland disrupting thyroid functions. The Environmental Protection Agency has set Interim Drinking Water Health Advisory level at (15 μg/l) for perchlorate. Several state guidelines are in the 1-6 μg/l range.

Perchlorate can be removed from water by strong base anion removal ion exchange resins. Examples of resins used for perchlorate removal are Dowex PSR-2 (Dow Chemical Co., Midland, Mich.), Amberlite PWA2 (Rohm and Haas, Phildelphia, Pa. now part of Dow Chemical Co., Midland, Mich.) and Purolite A532E (Purlolite Corp, Bala Cynwyd Pa.).

Due to contamination, the water from contaminated aquifers must be remediated before distribution into domestic drinking water supply. One common method for removal of contaminants is use of anion exchange resin. Contaminants such as nitrate and perchlorate are adsorbed onto the resin. Treated water is able to meet drinking water standards. Eventually the anion resin is “saturated” or “spent” or “exhausted” or “loaded” (these terms can be used interchangeably) with the contaminants and must be regenerated, in the case of nitrate, or disposed of, in the case of perchlorate. Perchlorate binds so tightly that regeneration cannot be accomplished using standard methods. Perchlorate-loaded anion resin can be disposed of in a landfill, but this is not considered to be an effective solution because of concern that perchlorate could again be released into ground water over the long term. The preferred disposal method is incineration. Incineration at high temperature actually destroys perchlorate compounds so they can not re-enter ground water.

Ion exchange resins are composed of polymeric polystyrene and other organic compounds. Therefore spent resin may be beneficially incinerated to provide BTU value as recovered heat to run boilers that generate electrical power—i.e., “waste to energy”.

When ion exchange resin alone is used, uranium loading is possible only to <0.05% by mass because of NRC regulation 10CFR40.13. In some cases, there is enough uranium in the aquifer to exceed this level before the resin is saturated with perchlorate. Two options exist in this case. First, continue to use the resin until it is saturated with perchlorate even though uranium is loaded to >0.05%. In this event, the spent resin is not exempt from the Nuclear Regulatory Commission (NRC) rule and must be treated as a source material. This means that special equipment, training, personnel, disposal, inspection, transportation and reporting must be done. Disposal of resin that is source material is very expensive and limited to very few locations. Handling spent resin as source material is problematic and every effort is made to avoid it. Therefore, another option is to remove and replace the resin from use when uranium loading is <0.05% even if the resin is not saturated with perchlorate. The spent resin can be incinerated at reasonable cost. The trade off is higher operating cost due to more frequent resin replacement because the resin is replaced before perchlorate breakthrough has been achieved.

The addition of anthracite as a flow dispersion layer has the benefit of better flow characteristics in the operating ion exchange treatment system and synergistically allows better resin utilization. Anthracite provides additional mass (resin+anthracite) in the treatment tank but does not adsorb uranium. This allows the resin to adsorb more uranium than when anthracite is absent while remaining <0.05% uranium based on total bed volume. As shown in the Example 4, loading of 60% more uranium is possible in actuality since the resin and anthracite are saturated with water. This is beneficial in waters with higher uranium, allowing the resin to operate longer than previously and resulting in lower operating costs since resin is replaced less often and disposal can be done as a non-source material, often in waste to energy facilities.

It is important to note that incineration can only be done when a material such as anthracite is used in conjunction with the ion exchange bed, because with a non-incinerating material, the residual may have a uranium content that is not exempt from the Nuclear Regulatory Commission (NRC) rule and must be treated as a source material adding costs and handling complexity to the remediation process. Anthracite is beneficial for this because it is clean burning with a low ash content and the highest heat of combustion of coals.

### Examples

These examples are shown to illustrate the general technology. The description given and the examples described are meant to be guidelines for those skilled in the art, and are not meant to be limiting in any manner.

### Example 1

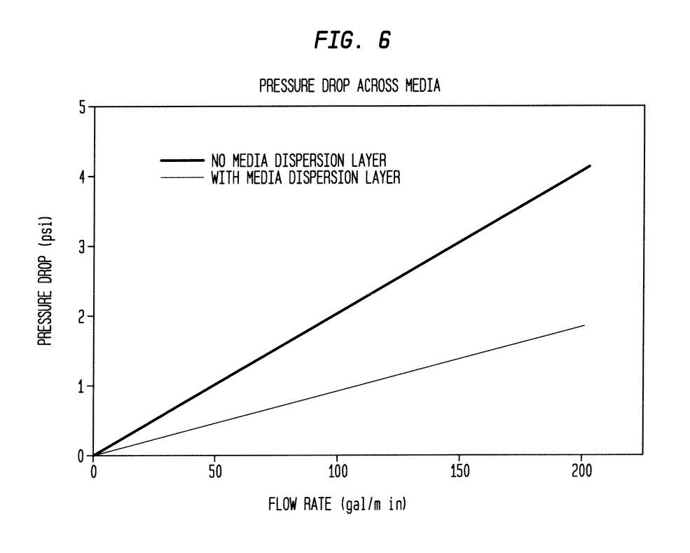

A 4 foot diameter, elliptical-bottom ion exchange vessel, with bottom lateral strainers was used in a controlled experiment. Thirty-five (35) cubic feet of Dowex PSR-2 ion exchange resin (bead size 0.4-1.2 mm) was added to the tank. Water was pumped through the tank and ion exchange resin, the flow rate incrementally raised to 200 gallons per minute (gpm). Influent and effluent pressure readings were made at selected flow rates. The pressure drop across the tank and ion exchange resin was calculated by subtracting the effluent pressure from the influent pressure. These data are graphically displayed in FIG. 6 as the line labeled “no media dispersion layer.” Media dispersion and flow dispersion are equivalent terms. The ion exchange resin was removed and 10 cubic feet of a anthracite particle flow dispersion media (1.50-1.75 mm) was added to the bottom of the tank. The same anion exchange resin was replaced in the tank on top of the flow dispersion layer and the test repeated. Pressure drop across the tank are graphically displayed above as the line labeled “with media dispersion layer.” As can be seen, use of the media dispersion layer enhances flow as evidenced by a lower pressure drop. Further the benefit of enhanced flow is greater at higher flow rates through the tank and ion exchange resin.

### Example 2

A 10 foot diameter, conical bottom tank with strainers protruding through the bottom and filled with 350 cubic feet of ion exchange resin, was used to remediate ground water for use as domestic drinking water for a period of 8 months. During this period, the normalized differential pressure across the tank was about 12 psi/kgal. (Normalized differential pressure is calculated by subtracting the effluent pressure from the influent pressure and dividing by the flow rate through the tank in thousands of gallons (kgal) per minute.) The ion exchange resin was removed and 135 cubic feet of flow dispersion media (anthracite, 1.50-1.75 mm) was placed into the tank, filling the conical bottom section. Two hundred eighty (280) cubic feet of the same ion exchange resin was replaced in the tank and flow was restarted. The normalized differential pressure after restart was maintained at 8 psi/kgal for a period of 6 months, after which pressure monitoring ceased. Note that the differential pressure decreased even though the depth of the bed increased by a total of one foot (ion exchange+flow dispersion media).

### Example 3

A 10 foot diameter, conical bottom tank with strainers protruding through the bottom and filled with 350 cubic feet of ion exchange resin, was used to remediate ground water for use as domestic drinking water for a period of 2 months. During this period, the normalized differential pressure across the tank was about 11 psi/kgal. The ion exchange resin was removed and 135 cubic feet of flow dispersion media (anthracite, 1.50-1.75 mm) was placed into the tank, filling the conical bottom section. Two hundred eighty (280) cubic feet of the same ion exchange resin was replaced in the tank and flow was restarted. The normalized differential pressure after restart was maintained at 7 psi/kgal for a period of 2 months, after which pressure monitoring ceased. Note that the differential pressure decreased even though the depth of the resin bed increased by a total of one foot (ion exchange+flow dispersion media).

### Example 4

Illustrating the benefit of mass of anthracite used as a flow dispersal layer on disposal if uranium loads onto ion exchange resin. Chapter 1, Section 40.13 (Nuclear Regulatory Commission) exempts any person from the licensing of the section when the source material is by weight less than one-twentieth of 1 percent (0.05 percent) of the mixture, compound, solution or alloy.

A tank such as that described in Examples 2 and 3 is filled with 280 cubic feet of ion exchange resin, which weighs 11,760 lbs. Assume that the well treated by the ion exchange system contains uranium, which loads onto the resin. If the resin loads more than 0.05% (500 ppm) of uranium, it is not exempt from handling under the NRC's regulation cited above. Calculating (11,760×0.05%) results in a maximum of 5.9 lbs of uranium allowed being loaded on the resin. Anthracite placed into the bottom of this tank as a flow dispersion layer adds 135 cubic feet weighing 7,020 lbs, for a total weight of resin and anthracite of 18,780 lbs. Uranium will not adsorb onto anthracite. Calculating (18,780×0.05%) results in a maximum of 9.4 lbs of uranium allowed on the combined resin and anthracite. This is a 60% increase in the mass of uranium that may be loaded on to the resin while remaining exempt. Some wells contain sufficient uranium that in excess of 0.05% will load onto the resin before it is spent by the contaminant being remediated from the well water. Removing the resin early represents extra cost. Using an anthracite flow dispersion layer allows significantly greater resin utilization before it needs to be removed. In some cases, operating time for the resin is extended long enough for the resin to be exhausted by the primary contaminant rather than reach the maximum uranium content.

What is claimed is:

1. An apparatus for removing ionic impurities from water comprising:
a vessel having a shaped bottom with an liquid inlet for water to be treated and at least one bottom liquid flow strainer,
said vessel containing a bed of ion exchange media,
said vessel further including a flow dispersion layer of anthracite particles covering said at least one bottom liquid flow strainer.

2. The apparatus of claim 1 wherein the anthracite particles are of a size between from about approximately 8 mesh to about approximately 16 mesh, which corresponds to from about approximately 2.38 mm (millimeters) to about approximately 1.19 mm.

3. The apparatus of claim 1 wherein the anthracite particles are of a size between from about approximately 10 mesh to about approximately 14 mesh, which corresponds to from about approximately 2.00 mm (millimeters) to about approximately 1.41 mm.

4. The apparatus of claim 1 wherein the anthracite particles are of a size between from about approximately 1.50 mm (millimeters) to about approximately 1.75 mm

5. An apparatus for removing an ionic radionuclide from water comprising:
a vessel having a shaped bottom with an inlet for water to be treated and at least one bottom liquid flow strainer,
said vessel containing a bed of ion exchange media,
said vessel further containing a flow dispersion layer of combustible and non-radionuclide sorbing particles covering said at least one bottom liquid flow strainer.

6. The apparatus of claim 6 wherein the radionuclide is uranium.

7. The apparatus of claim 6 wherein the combustible and non-radionuclide sorbing particles are anthracite particles.

8. The apparatus of claim 7 wherein the anthracite particles are of a size between from about approximately 8 mesh to about approximately 16 mesh, which corresponds to from about approximately 2.38 mm (millimeters) to about approximately 1.19 mm.

9. The apparatus of claim 7 wherein the anthracite particles are of a size between from about approximately 10 mesh to about approximately 14 mesh, which corresponds to from about approximately 2.00 mm (millimeters) to about approximately 1.41 mm.

10. The apparatus of claim 7 wherein the anthracite particles are of a size between from about approximately 1.50 mm (millimeters) to about approximately 1.75 mm.

11. A method for removal of ionic contaminants from water by ion exchange and volume reduction of the ion exchange resin bed comprising the steps of:
treating the water with an apparatus including;
a vessel having a shaped bottom with an inlet for water to be treated and at least one bottom liquid flow strainer,
said vessel containing a bed of ion exchange media,
said vessel further containing a flow dispersion layer of combustible particles covering said at least one bottom liquid flow strainer, and,
after attainment of ion exchange bed breakthrough point,
combusting together the ion exchange bed and said combustible particles.

12. The method of claim 11 wherein the combustible particles include coal.

13. The method of claim 12 wherein the combustible comprise particles include anthracite.

14. The method of claim 13 wherein the anthracite particles are of a size between from about approximately 8 mesh to about approximately 16 mesh, which corresponds to from about approximately 2.38 mm (millimeters) to about approximately 1.19 mm.

15. The method of claim 13 wherein the anthracite particles are of a size between from about approximately 10 mesh to about approximately 14 mesh, which corresponds to from about approximately 2.00 mm (millimeters) to about approximately 1.41 mm

16. The method of claim 13 wherein the anthracite particles are of a size between from about approximately 1.50 mm (millimeters) to about approximately 1.75 mm.

17. A method for removal of an ionic radionuclide from water by ion exchange and volume reduction of the ion exchange resin bed comprising the steps of:
treating the water source with an apparatus comprising;
a vessel having a shaped bottom with an inlet for water to be treated and at least one bottom liquid flow strainer,
said vessel containing a bed of ion exchange media,
said vessel further containing a flow dispersion layer of combustible and non-radionuclide sorbing particles covering said at least one bottom liquid flow strainer, and,
after attainment of ion exchange bed breakthrough point,
combusting together the ion exchange bed and combustible and non-radionuclide sorbing particles.

18. The method of claim 17 wherein the radionuclide is uranium.

19. The method of claim 17 wherein the combustible and non-radionuclide sorbing particles comprise coal.

20. The method of claim 19 wherein the combustible and non-uranium sorbing particles comprise anthracite.

21. The method of claim 20 wherein the anthracite particles are of a size between from about approximately 8 mesh to about approximately 16 mesh, which corresponds to from about approximately 2.38 mm (millimeters) to about approximately 1.19 mm.

22. The method of claim 20 wherein the anthracite particles are of a size between from about approximately 10 mesh to about approximately 14 mesh, which corresponds to from about approximately 2.00 mm (millimeters) to about approximately 1.41 mm.

23. The method of claim 20 wherein the anthracite particles are of a size between from about approximately 1.50 mm (millimeters) to about approximately 1.75 mm.

24. A method for removal of an uranium from water by ion exchange followed by volume reduction of the ion exchange resin bed comprising the steps of:
treating the water source with an apparatus comprising;
a vessel having a shaped bottom with an inlet for water to be treated and at least one bottom liquid flow strainer,
said vessel containing a bed of ion exchange media,
said vessel further containing a flow dispersion layer of anthracite particles covering said at least one bottom liquid flow strainer, and,
after attainment of ion exchange bed breakthrough point,
combusting together the ion exchange bed and anthracite particles.

25. The method of claim 24 wherein the anthracite particles are of a size between from about approximately 8 mesh to about approximately 16 mesh, which corresponds to from about approximately 2.38 mm (millimeters) to about approximately 1.19 mm.

26. The method of claim 24 wherein the anthracite particles are of a size between from about approximately 10 mesh to about approximately 14 mesh, which corresponds to from about approximately 2.00 mm (millimeters) to about approximately 1.41 mm.

27. The method of claim 24 wherein the anthracite particles are of a size between from about approximately 1.50 mm (millimeters) to about approximately 1.75 mm.

28. A method for removal of an perchlorate anion from water by ion exchange followed by volume reduction of the ion exchange resin bed comprising the steps of:
treating the water source with an apparatus comprising;
a vessel having a shaped bottom with an inlet for water to be treated and at least one bottom liquid flow strainer,
said vessel containing a bed of ion exchange media,
said vessel further containing a flow dispersion layer of anthracite particles covering said at least one bottom liquid flow strainer, and,
after attainment of ion exchange bed breakthrough point,
combusting together the ion exchange bed and anthracite particles.

29. The method of claim 28 wherein the ion exchange resin is a strong base anion exchange resin.

30. The method of claim 28 wherein the anthracite particles are of a size between from about approximately 8 mesh to about approximately 16 mesh, which corresponds to from about approximately 2.38 mm (millimeters) to about approximately 1.19 mm.

31. The method of claim 28 wherein the anthracite particles are of a size between from about approximately 10 mesh to about approximately 14 mesh, which corresponds to from about approximately 2.00 mm (millimeters) to about approximately 1.41 mm.

32. The method of claim 28 wherein the anthracite particles are of a size between from about approximately 1.50 mm (millimeters) to about approximately 1.75 mm.
